(19) United States
(12) Patent Application Publication
(10) Pub. No.: US 2026/0128623 A1
(43) Pub. Date: May 7, 2026

(54) Electric Motor

(71) Applicant: Supernal, LLC, Washington, DC (US)

(72) Inventor: Siavash Sadeghi, Irvine, CA (US)

(21) Appl. No.: 19/115,938

(22) PCT Filed: Oct. 17, 2023
(86) PCT No.: PCT/US2023/035353

§ 371 Date: Mar. 27, 2025

Related U.S. Application Data
(60) Provisional application No. 63/417,359, filed on Oct. 19, 2022.

(51) Int. Cl. H02K 1/14; B64C 29/00; B64D 27/34; B64D 27/357; B64D 31/16; H02K 1/27; H02K 7/08; H02K 11/33; H02P 27/06

(52) U.S. Cl. CPC H02K 1/14; B64C 29/00; B64D 27/34; B64D 27/357; B64D 31/16; H02K 1/27; H02K 7/08; H02K 11/33; H02P 27/06

(57) ABSTRACT

An example electric motor includes: a stator having (i) a first set of windings configured to generate a radial magnetic flux when electric current is provided thereto, and (ii) a second set of windings configured to generate an axial magnetic flux when electric current is provided thereto; and a rotor comprising (i) a first set of magnets configured to interact with the radial magnetic flux generated by the first set of windings of the stator, and (ii) a second set of magnets configured to interact with the axial magnetic flux generated by the second set of windings of the stator.

### CROSS-REFERENCE TO RELATED APPLICATION

The present application claims priority to U.S. Provisional Application No. 63/417,359 filed Oct. 19, 2022, the contents of which are hereby incorporated by reference in its entirety.

### BACKGROUND

Many systems involving machinery or vehicles are being electrified. Particularly, electric motors are used to drive rotary components such as propellers, wheels, or any other rotary component.

An electric motor is a machine that transforms electrical energy into mechanical energy by the action of magnetic fields generated in its coils. They are usually called rotating electric machines and are composed of a stator and a rotor, some of which can function as motors or generators.

In many applications, it may be desirable to reduce the weight and size of electric motors without reducing power output. It is may thus be desirable to have a highly-efficient, power dense, light-weight, and compact electric motor. It is with respect to these and other considerations that the disclosure made herein is presented.

### SUMMARY

The present disclosure describes implementations that relate to an electric motor, and, more particularly, to an electric motor having a stator with a first set of windings providing a radial magnetic flux and a second set of windings providing an axial magnetic flux.

In a first example implementation, the present disclosure describes an electric motor. The electric motor comprises: a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto; and a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator.

In a second example implementation, the present disclosure describes a system. The system includes the electric motor of the first example implementation. The system further includes: at least one motor controller comprising: (i) one or more inverter boards, each inverter board having a semiconductor switching matrix mounted thereon, wherein the semiconductor switching matrix comprises a plurality of semiconductor switching devices configured to convert direct current (DC) power to three-phase alternating current (AC) power to drive windings of the stator, and (ii) one or more controller boards that are electrically-coupled to the one or more inverter boards, wherein each controller board comprises a processor configured to generate a switching signal to operate the semiconductor switching matrix of a respective inverter board.

In a third example implementation, the present disclosure describes a vehicle. The vehicle includes a propeller or lift rotor and the electric motor of the first example implementation configured to drive the propeller or lift rotor. The vehicle further includes at least one motor controller comprising: (i) one or more inverter boards, each inverter board configured to convert direct current (DC) power to three-phase alternating current (AC) power to drive windings of the stator; and (ii) one or more controller boards that are electrically-coupled to the one or more inverter boards, wherein each controller board comprises a processor configured to operate a respective inverter board. The vehicle also includes a plurality of battery modules configured provide DC power to the at least one motor controller to be converted by the one or more inverter boards to AC power.

In a fourth example implementation, the present disclosure describes a method. The method includes providing direct current (DC) power from a first power source to a first motor controller, wherein the first motor controller comprises: (i) a first inverter board configured to convert the DC power to three-phase alternating current (AC) power to drive a first set of windings of a stator of an electric motor, and (ii) a first controller board that is electrically-coupled to the first inverter board, wherein the first controller board generates a first switching signal to operate the first inverter board, wherein the first set of windings are configured to generate a radial magnetic flux when electric current is provided thereto, wherein the stator further comprises a second set of windings configured to generate an axial magnetic flux when electric current is provided thereto, and wherein the electric motor further comprises: a rotor comprising (i) a first set of magnets configured to interact with the radial magnetic flux generated by the first set of windings, and (ii) a second set of magnets configured to interact with the axial magnetic flux generated by the second set of windings. The method also includes providing DC power from a second power source to a second motor controller, wherein the second motor controller comprises: (i) a second inverter board configured to convert the DC power to three-phase AC power to drive the second set of windings, and (ii) a second controller board that is electrically-coupled to the second inverter board, wherein the second controller board generates a second switching signal to operate the second inverter board.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE FIGURES

FIG. 1 is a block diagram of a vehicle, according to exemplary embodiments of the present invention.

FIG. 2 illustrates a perspective front view of an electric motor, according to exemplary embodiments of the present invention.

FIG. 3 illustrates a bottom view of the electric motor of FIG. 2, according to exemplary embodiments of the present invention.

FIG. 4 illustrates a perspective side view of the electric motor of FIG. 2, according to exemplary embodiments of the present invention.

FIG. 5 illustrates a perspective side view of a stator of the electric motor of FIGS. 2-4, according to exemplary embodiments of the present invention.

FIG. 6 illustrates a perspective front view of the stator of FIG. 5, according to exemplary embodiments of the present invention.

FIG. 7 illustrates a perspective side view of a rotor of the electric motor of FIGS. 2-4, according to exemplary embodiments of the present invention.

FIG. 8 illustrates a perspective front view of the rotor of FIG. 7, according to exemplary embodiments of the present invention.

FIG. 9 illustrates a system having a motor controller, according to exemplary embodiments of the present invention.

FIG. 10 illustrates a system having a motor controller with a first inverter board driving a first set of windings and a second inverter board driving a second set of windings, according to exemplary embodiments of the present invention.

FIG. 11 illustrates a system having a first motor controller driving a first set of windings and a second motor controller driving a second set of windings, according to exemplary embodiments of the present invention.

FIG. 12 is a flowchart of a method 800 for operating a system, according to exemplary embodiments of the present invention.

### DETAILED DESCRIPTION

Disclosed herein are systems involving an electric motor having a stator with a first set of windings providing a radial magnetic flux and a second set of windings providing an axial magnetic flux. In one embodiment, a rotor of the electric motor may have a first set of magnets disposed in a circular array about a peripheral surface of the rotor to interact with the first set of windings of the stator. The rotor may also include a second set of magnets facing the second set of windings of the stator. For example, the second set of magnets can be placed on an end plate of the rotor.

The disclosed system may be utilized in any device or application that utilizes a motor. For example, the motor may be used to power or drive a vehicle, including but not limited to a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone). The disclosed embodiments of the present invention may be utilized in any of these applications in order to obtain advantages such as compactness, light weight, enhanced power density, and higher efficiency.

In some embodiments, each set of windings of the stator are controlled separately. In other words, power provided to the first set of windings may be independently controlled from the power that may be provided to the second set of windings. One advantage of such an arrangement is that if one power source or controller fails, the electric motor can continue to maintain operation.

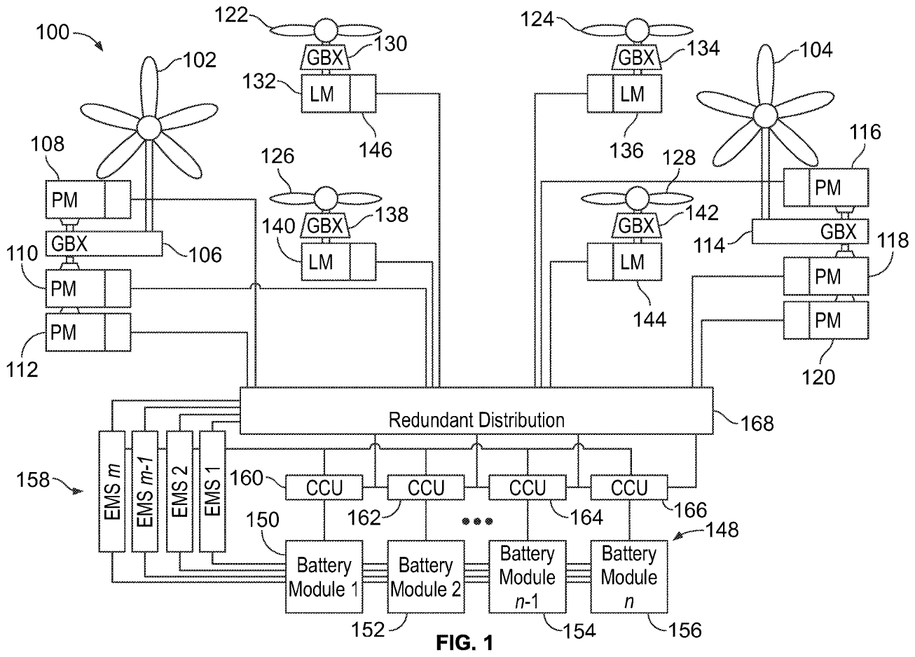

FIG. 1 is a block diagram of a vehicle 100, according to an exemplary embodiment of the present invention. In some embodiments, and as noted above, the vehicle 100 may be a VTOL, which may or may not use electric power to hover, takeoff, and/or land. It should be understood that in other embodiments, the vehicle 100 may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

In some embodiments, the vehicle 100 may include one or more propellers used to drive the vehicle, such as propellers 102, 104, 122, 124, 126, and 128 illustrated in FIG. 1. Each propeller may be configured, for examples, as tiltrotors, lift rotors, or any other type of rotors. In other embodiments, the vehicle 100 may include one or more turbine engines, one or more tires, one or more ski-structures, or the like instead of the one or more propellers used to drive the vehicle.

The first propeller 102 may be driven by a gearbox 106, which in turn is driven by one or more motors such as propeller motor 108, propeller motor 110, and propeller motor 112. Similarly, the second propeller 104 is driven by a gearbox 114, which in turn is driven by one or more motors such as propeller motor 116, propeller motor 118, and propeller motor 120. In some embodiments, the motors may be electric motors.

The vehicle 100 also may include multiple lift rotors, such as multiple lift rotors that can facilitate vertical takeoff and landing of the vehicle 100. For example, the vehicle 100 can include a lift rotor 122, a lift rotor 124, a lift rotor 126, and a lift rotor 128.

The lift rotor 122 is driven by a gearbox 130, which in turn is driven by a motor 132. The lift rotor 124 is driven by a gearbox 134, which in turn is driven by a motor 136. The lift rotor 126 is driven by a gearbox 138, which in turn is driven by a motor 140. The lift rotor 128 is driven by a gearbox 142, which in turn is driven by a motor 144.

In one embodiment, each of the motors described above may include one or more respective motor controllers integrated therewith. For example, the lift motor 132 has one or more motor controllers 146 integrated therewith. Example motor controllers are described below.

In some embodiments, the various motors of the vehicle 100 may be electric motors driven by electric power provided by a plurality of batteries. As depicted in in FIG. 1, the vehicle 100 can have “n” battery modules 148, such as battery module 150, battery module 152, battery module 154, and battery module 156. In an example, the battery modules can be Lithium-ion (Li-Ion) batteries. Each battery module can include a housing or enclosure that houses a plurality of battery cells arranged in rows and columns.

The battery modules 148 are configured to store electric power, and provide electric power to the various electric motors when commanded by respective energy management systems of the vehicle 100. Particularly, in an example implementation, the vehicle 100 can have a plurality (“m”) of energy management systems (EMSs) 158 that are in communication with the battery modules 148. The EMSs 158 are configured as electronic regulators that monitor and control the charging and discharging of the battery modules 148.

In an example, the EMSs 158 are configured to measure voltages of the battery modules 148 and stop charging them when a desired voltage is reached. Further, the EMSs 158 can be configured to monitor parameters that affect life and/or performance of the battery modules 148 as well as ensuring safe operation of the battery modules 148. Safe operation includes, as examples, operating below a threshold temperature to elongate the life of the battery modules 148; preclude overheating, preclude failure of the battery modules, 148, etc.

The EMSs 158 can monitor and control parameters of the battery modules 148. For example, the EMSs 158 monitor and control main power voltage, battery or cell voltage, charging and discharge rates of the battery modules 148, temperatures of the battery modules 148 or their individual cells, health of the battery modules 148 or their individual cells, coolant temperature and flow for air or liquid cooling parameters of a cooling system of the battery modules 148 or their individual cells, etc.

The vehicle 100 may further include multiple contactor control units (CCUs), such as CCU 160, CCU 162, CCU 164, and CCU 166, which are electrically coupled to the battery modules 148, and are in communication with the EMSs 158. In one embodiment, as illustrated in FIG. 1, each CCU is coupled to a respective battery module of the battery modules 148. A contactor is an electrically-controlled switch used for switching an electrical power circuit. A CCU controls the actuation of the contactor to allow power flow to and from the respective battery module. For example, the EMSs 158 control the power flow to and from the battery modules 148 based on power demand from the various electric motors, and accordingly control the CCUs to enable power flow from particular battery modules as desired.

The vehicle 100 may be configured to include a distributed electric propulsion system configured to provide the vehicle 100 with the required energy to power the multiple propellers and lift rotors via an electric transmission system. Particularly, the vehicle 100 can include a redundant distribution module 168 in communication with the EMSs 158, and the redundant distribution module 168 is electrically coupled to the battery modules 148 via the respective CCUs, and is configured to provide electric power, via transmission lines, to the multiple electric motors of the vehicle 100.

The EMSs 158 along with the redundant distribution module 168 can provide for redundancy in the vehicle 100 such that if, for example, one propeller or one lift rotor fails, power can be distributed to other propellers or lift rotors to maintain operation of the vehicle 100.

Due to weight and space constraints in a vehicle such as the vehicle 100, it may be desirable to have electric motors with increased power density and efficiency, while reducing envelope size of the electric motors. Described next is an electric motor with a configuration that renders the electric motor power dense and compact. The electric motor can represent any of the electric motors described above with respect to FIG. 1.

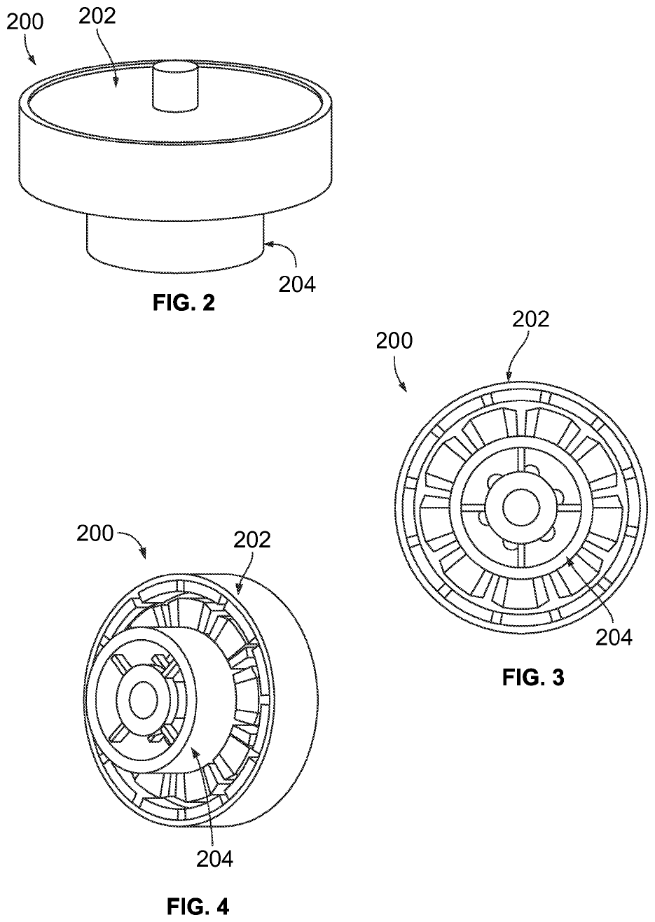

FIG. 2 illustrates a perspective front view of an electric motor 200, FIG. 3 illustrates a bottom view of the electric motor 200, and FIG. 4 illustrates a perspective side view of the electric motor 200, according to exemplary embodiments of the present invention. FIGS. 2-4 are described together.

The electric motor 200 may include a rotor 202 and a stator 204, where the stator 204 is disposed, at least partially, within the rotor 202. In one embodiment, the stator 204 has a plurality of windings that, when electric current is provided thereto, generate a magnetic field. The rotor 202 has a plurality of magnets that interact with the magnetic field generated by the stator 204, causing the rotor 202 to rotate.

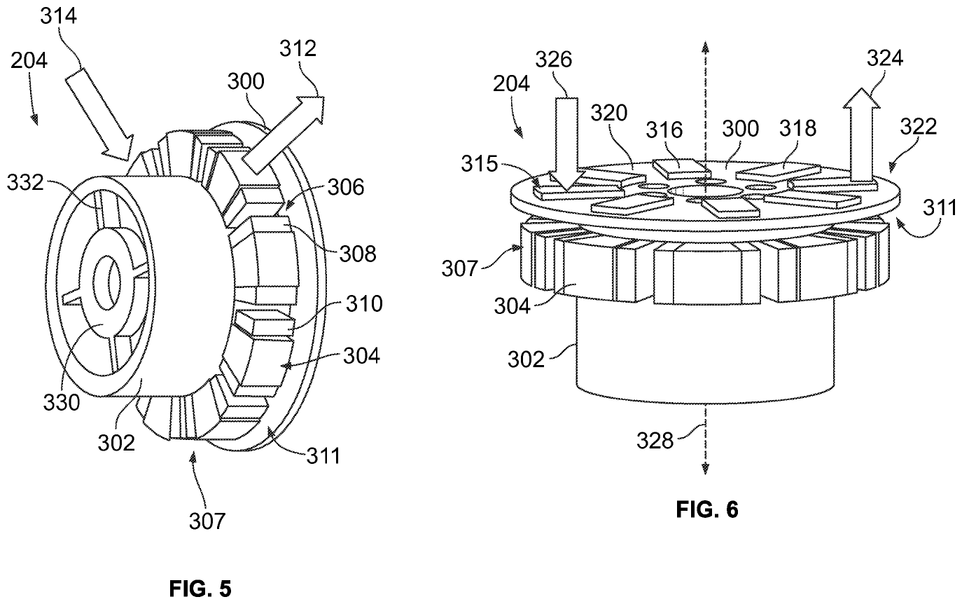

FIG. 5 illustrates a perspective side view of the stator 204, and FIG. 6 illustrates a perspective front view of the stator 204, according to exemplary embodiments of the present invention. The stator 204 may comprise a stator plate 300 and a stator hub 302 that is mounted or coupled to the stator plate 300. In one example, the stator plate 300 and the stator hub 302 can be separate components that are affixed or coupled to each other. In another example, the stator plate 300 and the stator hub 302 are made as an integral single component.

Referring to FIG. 5, the stator 204 may include a stator core 304. In an example, the stator core 304 includes one or more stator lamination stacks, each lamination stacking including a plurality of laminations (e.g., thin metal sheets that are stacked together). Particularly, the stator core 304 can include laminations of ferrous material (e.g., iron), that are separated by non-conducting, non-ferrous layers to minimize losses due to eddy currents of magnetic flux within the stator 204.

The one or more lamination stacks define grooves therebetween such as groove 306. The stator 204 may include a first set of windings 307, such as windings 308 and windings 310. In an example, windings are conductive coils including loops of insulated copper wire placed within the grooves defined by the stator core 304, such that each winding forms a loop surrounding two intervening grooves of the stator core 304. The first set of windings 307 are disposed in a circular array about the exterior peripheral surface of the stator hub 302 on a first side 311 of the stator plate 300. When electric current is provided through the windings of the first set of windings 307 (e.g., the windings 308, 310), a magnetic flux having a radial direction represented by arrow 312 and arrow 314 is generated. In other words, magnetic flux emanate from the first set of windings 307 as radial lines or rays pointing to or from a center of the stator plate 300 or the center of the stator hub 302.

Referring to FIG. 6, the stator 204 may further include a second set of windings 315, such as windings 316 and windings 318. In an example, windings of the second set of windings 315 are conductive coils including loops of insulated copper wire placed on an exterior end face 320 of the stator plate 300 on a second side 322 of the stator plate 300 opposite the first side 311 thereof. In an example, as depicted in FIG. 6, the second set of windings 315 are disposed in a circular array about the exterior end face 320 of the stator plate 300.

In one embodiment, when electric current is provided through the windings of the second set of windings 315 (e.g., the windings 308, 310), a magnetic flux having an axial direction represented by arrow 324 and arrow 326 is generated. As such, magnetic flux generated by the second set of windings 315 (e.g., the windings 316, 318) is parallel to a longitudinal axis 328 of the stator 204, whereas magnetic flux generated by the first set of windings 307 is perpendicular to the longitudinal axis 328. The longitudinal axis 328 is also

### The Rotation Axis of the Rotor 202.

Referring back to FIG. 5, in an example, the stator 204 further includes a bearing housing 330 disposed within the stator hub 302. The bearing housing 330 can be connected to an interior surface of the stator hub 302 via ribs such as a rib 332, for example. The bearing housing 330 can have a bearing that supports an output shaft (e.g., rotor shaft 404 described below) of the electric motor 200.

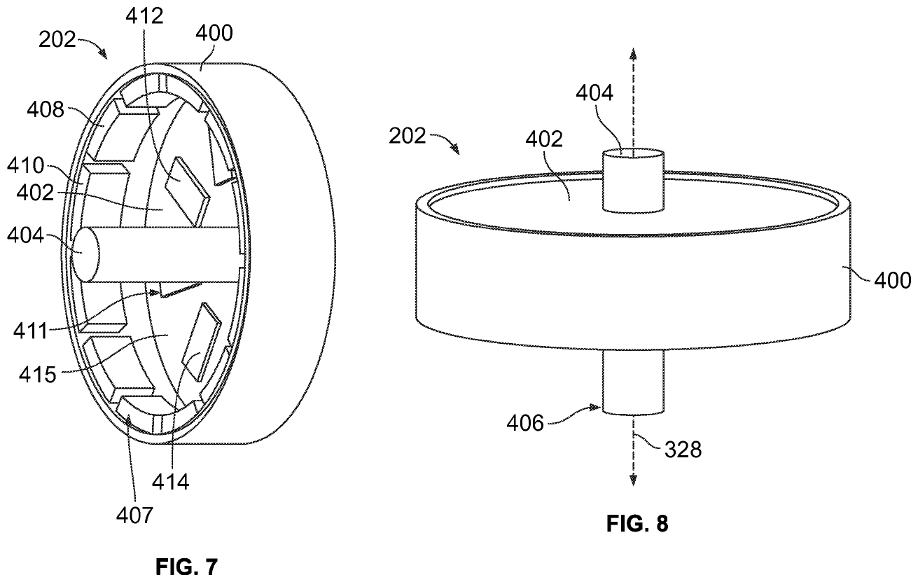

FIG. 7 illustrates a perspective side view of the rotor 202, and FIG. 8 illustrates a perspective front view of the rotor 202, according to exemplary embodiments of the present invention. The rotor 202 may include a rotor cylinder 400 and a rotor end plate 402. In one example, the rotor cylinder 400 and the rotor end plate 402 can be separate components that are affixed or coupled to each other. In another example, the rotor cylinder 400 and the rotor end plate 402 are made as an integral single component. The other end of the rotor cylinder 400 may be open to allow the stator 204 to be inserted into the rotor cylinder 400 through the open end of the rotor cylinder 400.

In one example, the rotor cylinder 400 may include cooling channels for cooling fluid circulation, such that the rotor cylinder 400 operates as a cooling jacket for the electric motor 200. In another example, the cooling jacket may be a different housing disposed about the assembly of the rotor 202 and the stator 204 shown in FIGS. 2-4.

The rotor 202 may further include a rotor shaft 404. For example, the rotor shaft 404 can be coupled to the rotor end plate 402. A distal end 406 of the rotor shaft 404 may rest in the bearing housing 330 of the stator 204 as shown in FIG. 4. The rotor shaft 404 is configured to be coupled to any of the gearboxes described above, for example.

The rotor 202 may have a first set of magnets 407, such as magnet 408 and magnet 410, disposed in a circular array about an interior peripheral surface of the rotor cylinder 400. In an example, the first set of magnets 407 can be attached to the rotor cylinder 400 by an adhesive (e.g., an acrylic adhesive). In an example, magnets of the first set of magnets 407 can be made of a neodymium-iron-boron (Nd—Fe—B) material.

The rotor 202 may further include a second set of magnets 411, such as magnet 412 and magnet 414, disposed in a circular array about an interior end face 415 of the rotor end plate 402. In an example, the second set of magnets 411 can be attached to the rotor end plate 402 by an adhesive (e.g., an acrylic adhesive) and can be made of Nd—Fe—B.

The stator 204 may be mounted, at least partially, within the rotor cylinder 400 of the rotor. When the stator 204 is mounted within the rotor cylinder 400, the first set of windings 307 of the stator 204 (e.g., the windings 308, 310) face the first set of magnets (e.g., the magnets 408, 410) of the rotor 202, and the second set of windings 315 of the stator 204 (e.g., the windings 316, 318) face the second set of magnets 411 (e.g., the magnets 412, 414) of the rotor 202.

With this configuration, when electric power provided to the first set of windings 307 of the stator 204, a radial magnetic flux is generated perpendicular to the longitudinal axis 328, and such radial magnetic flux interacts with the first set of magnets 407 of the rotor 202, causing the rotor 202 to rotate about the longitudinal axis 328 and causing a torque to be produced at the rotor shaft 404. Additionally, when electric power provided to the second set of windings 315 of the stator 204, an axial magnetic flux is generated parallel to the longitudinal axis 328, and such axial magnetic flux interacts with the second set of magnets 411 of the rotor 202, causing the rotor 202 to rotate about the longitudinal axis 328 and causing a second torque to be produced at the rotor shaft 404. Thus, having the two sets of windings and the two sets of magnets can have an additive effect to increase the speed and torque of the electric motor 200 in a compact package.

Although FIGS. 2-8 illustrate the stator 204 being placed inside the rotor 202, in other example implementations, the rotor may be placed within the stator. Particularly, a first set of magnets can be placed on an exterior peripheral surface (rather than an interior peripheral surface) of the rotor, and a second set of magnets can be placed on an exterior surface of its end plate. The stator on the other hand may have a first set of windings on its interior peripheral surface (e.g., inside a stator hub or cylinder) to interact with the first set of magnets, and a second set of windings to interact the second set of magnets. As such, the configuration of FIGS. 2-8 can be reversed.

Operation of the electric motor 200 is controlled by one or more motor controllers. In some examples, one motor controller can be used to control both sets of windings. In other examples, control of one set of windings is decoupled from control of the other set of windings.

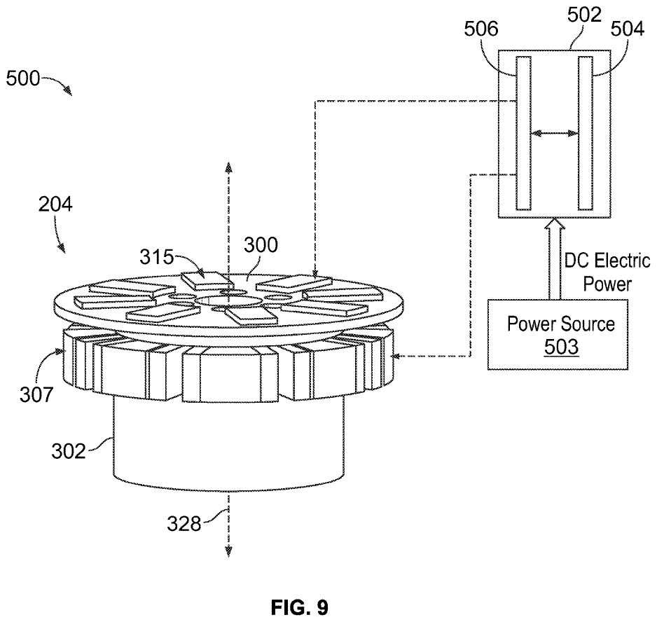

FIG. 9 illustrates a system 500 having a motor controller 502, according to exemplary embodiments of the present invention. The motor controller 502 can for example be mounted or attached to the rotor 202 or the stator 204 such that the motor controller 502 is included in the electric motor 200. In FIG. 9, only the stator 204 of the electric motor 200 is shown to reduce visual clutter in the drawings.

The motor controller 502 may be configured to receive direct current (DC) electric power from a power source 503 such as an electric generator (driven by an engine) or a battery (e.g., the battery modules 148), as examples. The motor controller 502 may include one or more printed circuit boards (PCBs). A PCB mechanically supports and electrically connects electronic components (e.g., microprocessors, integrated chips (ICs), capacitors, resistors, etc.) using conductive tracks, pads, and other features etched from one or more sheet layers of copper laminated onto and/or between sheet layers of a non-conductive substrate. Components are generally soldered onto the PCB to both electrically connect and mechanically fasten them to it.

As an example, the motor controller 502 can include a controller board 504 and an inverter board 506. In an example, the controller board 504 and the inverter board 506 can be integrated into one PCB. In another example, the controller board 504 and the inverter board 506 are separate and axially-offset from each other.

The inverter board 506 may include, for example, an arrangement of semiconductor switching elements (transistors) configured as a power converter that converts DC power received from the power source 503 at the inverter board 506 to multi-phase (e.g., three-phase), alternating current (AC) power that is provided to the first set of windings 307 and the second set of windings 315 of the stator 204 to drive the electric motor 200.

The controller board 504 may include one or more processors. A processor may include a general purpose processor (e.g., a single core microprocessor or a multicore microprocessor), or a special purpose processor (e.g., a digital signal processor, a graphics processor, or an application specific integrated circuit (ASIC) processor). A processor may be configured to execute computer-readable program instructions (CRPI) to perform the operations described throughout herein. A processor may be configured to execute hard-coded functionality in addition to or as an alternative to software-coded functionality (e.g., via CRPI).

The controller board 504 may be electrically coupled to the inverter board 506. Particularly, the one or more processors of the controller board 504 are configured to provide a pulse width modulated (PWM) switching signal to operate the power converter of the inverter board 506, for example.

In an example, the motor controller 502 can be integrated in a housing of the electric motor 200. This configuration may eliminate the need for external wires/cables from the motor controller 502 to the electric motor 200, thereby enhancing reliability of the electric motor 200. Also, the heat generated from the motor controller 502 (e.g., from the inverter board 506) during operation, can be dissipated via the housing of the electric motor 200, thereby enhancing efficiency and power density of the electric motor 200.

However, in other examples, the motor controller 502 can be contained within a separate housing that is then mounted to the housing of the electric motor 200. For instance, the motor controller 502 can be mounted to an exterior surface of the rotor 202.

As illustrated in FIG. 9, the inverter board 506 drives both sets of windings of the stator 204. In other examples, however, driving the first set of windings 307 can be decoupled from driving the second set of windings 315.

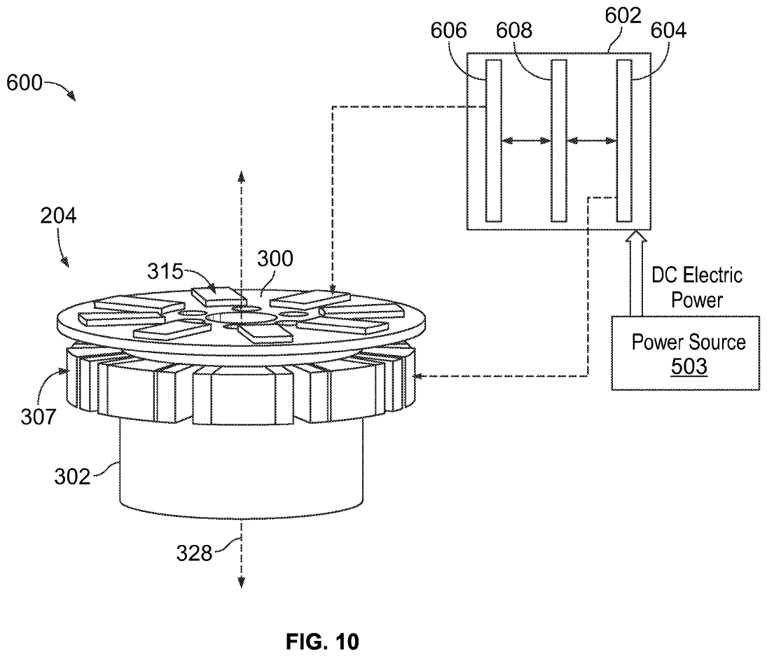

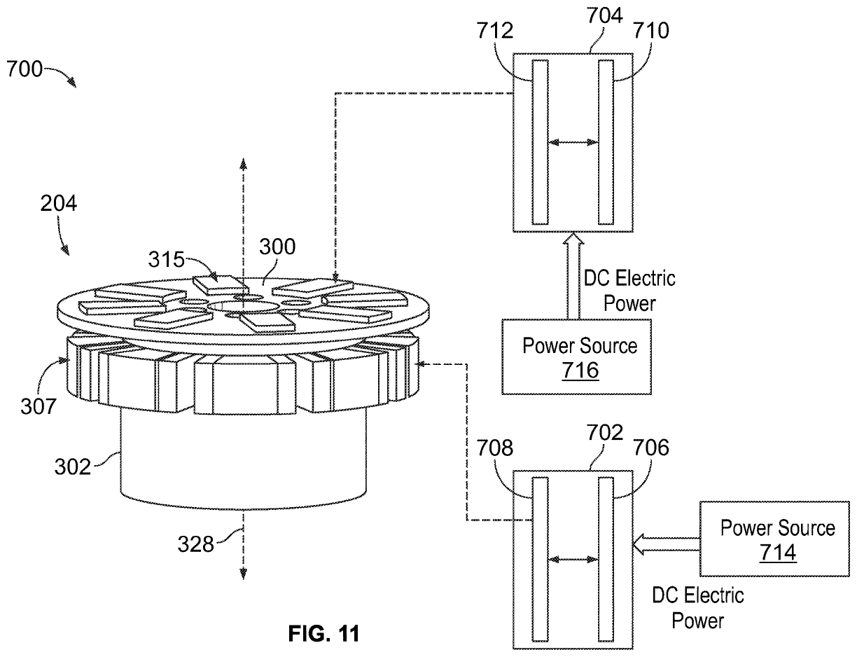

FIG. 10 illustrates a system 600 having a motor controller 602 with a first inverter board 604 driving the first set of windings 307 and a second inverter board 606 driving the second set of windings 315, according to exemplary embodiments of the present invention. As depicted in FIG. 10, the motor controller 602 may have a controller board 608 that provides PWM signals to operate both of the inverter boards 604, 606. Particularly, in some examples, the controller board 608 can provide a first switching signal to operate the first inverter board 604 and a second switching signal to operate the second inverter board 606.

In this example, however, the first inverter board 604 drives the first set of windings 307 independently from the second inverter board 606 driving the second set of windings 315. This configuration may enhance reliability of the system 600. Particularly, if one inverter board fails or malfunctions, the other inverter board may drive its respective set of windings to continue operating the electric motor 200.

FIG. 11 illustrates a system 700 having a first motor controller 702 driving the first set of windings 307 and a second motor controller 704 driving the second set of windings 315, according to exemplary embodiments of the present invention. The first motor controller 702 may have a first controller board 706 and a first inverter board 708. The first inverter board 708 may be configured to convert DC power received at the first inverter board 708 to three-phase, AC power that is provided to the first set of windings 307. The first controller board 706 may have a microprocessor that provides a first switching signal (e.g., a first PWM signal) to operate the power converter of the first inverter board 708.

Similarly, the second motor controller 704 may have a second controller board 710 and a second inverter board 712. The second inverter board 712 may be configured to convert DC power received at the second inverter board 712 to three-phase, AC power that is provided to the second set of windings 315. The second controller board 710 may have a microprocessor that provides a second switching signal (e.g., a second PWM signal) to operate the power converter of the second inverter board 712.

Advantageously, with this configuration, two separate motor controllers independently drive the two sets of windings of the stator 204. If one motor controller were to fail or malfunction, the other motor controller drives its respective set of stator windings to keep the electric motor 200 operating. As such, the configuration of FIG. 11 provides for redundancy that may enhance reliability of the system 700.

Further, in an example, a first power source 714 (e.g., a first battery module of the battery modules 148) may be providing DC power to the first motor controller 702, while a second power source 716 (e.g., a second battery module of the battery modules 148) may be providing DC power to the second motor controller 704. With this configuration, two separate power sources and two separate controllers independently drive the two sets of windings of the stator 204. In this manner, reliability of the system 700 may be enhanced. Further, controlling each set of windings independently may simplify control of the electric motor 200 and may enable enhancement in controlling speed and torque of the rotor shaft 404 (e.g., may enable increasing speed or torque, may more enable precise speed and torque control, etc.).

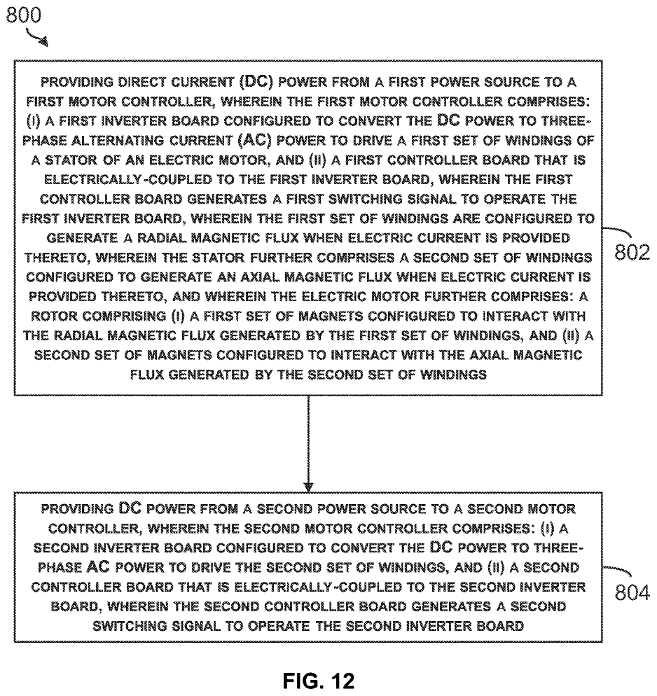

FIG. 12 is a flowchart of a method 800 for operating a system, according to exemplary embodiments of the present invention. The method 800 can, for example, be used to operate the system 700.

The method 800 may include one or more operations, or actions as illustrated by one or more of steps 802-804. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

In addition, for the method 800 and other processes and operations disclosed herein, the flowchart shows operation of one possible implementation of present examples. In this regard, each step may represent a module, a segment, or a portion of program code, which includes one or more instructions executable by a processor or a controller (e.g., by the EMSs 158 and the CCUs 160-166) for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 800 and other processes and operations disclosed herein, one or more steps in FIG. 8 may represent circuitry or digital logic that is arranged to perform the specific logical operations in the process.

As illustrated, the method 800 may include step 802 of providing direct current (DC) power from the first power source 714 to the first motor controller 702, wherein the first motor controller 702 comprises: (i) the first inverter board 708 configured to convert the DC power to three-phase alternating current (AC) power to drive the first set of windings 307 of a stator 204 of the electric motor 200, and (ii) the first controller board 706 that is electrically-coupled to the first inverter board 708, wherein the first controller board 706 generates a first switching signal to operate the first inverter board 708, wherein the first set of windings 307 are configured to generate a radial magnetic flux when electric current is provided thereto, wherein the stator 204 further comprises the second set of windings 315 configured to generate an axial magnetic flux when electric current is provided thereto, and wherein the electric motor 200 further comprises: the rotor 202 comprising (i) the first set of magnets 407 configured to interact with the radial magnetic flux generated by the first set of windings 307, and (ii) the second set of magnets 411 configured to interact with the axial magnetic flux generated by the second set of windings 315.

The method 800 may also include step 804 of providing DC power from the second power source 716 to the second motor controller 704, wherein the second motor controller 704 comprises: (i) the second inverter board 712 configured to convert the DC power to three-phase AC power to drive the second set of windings 315, and (ii) the second controller board 710 that is electrically-coupled to the second inverter board 712, wherein the second controller board 710 generates a second switching signal to operate the second inverter board 712.

The method 800 may include further additional steps as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example implementation (EEEs) listed below.
EEE 1 is an electric motor comprising: a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto; and a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator.
EEE 2 is the electric motor of EEE 1, wherein the stator comprises: a stator plate; and a stator hub mounted to the stator plate, wherein the first set of windings are disposed in a circular array about a peripheral surface of the stator hub on a first side of the stator plate, and wherein the second set of windings are disposed in a circular array about an end face of the stator plate on a second side of the stator plate, opposite the first side.
EEE 3 is the electric motor of EEE 2, wherein the stator hub comprises a bearing housing configured to have a bearing that supports a rotor shaft coupled to the rotor.
EEE 4 is the electric motor of any of EEEs 1-3, wherein the rotor comprises: a rotor cylinder; and a rotor end plate coupled to the rotor cylinder, wherein the first set of magnets are disposed in a circular array about a respective peripheral surface of the rotor cylinder, and wherein the second set of magnets are disposed in a circular array about a respective end face of the rotor end plate.
EEE 5 is the electric motor of EEE 4, wherein the first set of magnets are disposed in a circular array about an interior peripheral surface of the rotor cylinder, wherein the second set of magnets are disposed in a circular array about an interior end face of the rotor end plate, wherein the first set of windings are disposed in a circular array about an exterior peripheral surface of the stator, wherein the second set of windings are disposed in a circular array about an exterior end face of the stator, and wherein the rotor cylinder has an open end through which the stator is inserted, such that the stator is disposed, at least partially, within the rotor cylinder.
EEE 6 is the electric motor of any of EEEs 4-5, wherein the rotor further comprises a rotor shaft coupled to the rotor end plate and configured to rotate about a longitudinal axis of the rotor shaft, wherein the radial magnetic flux is perpendicular to the longitudinal axis, and wherein the axial magnetic flux is parallel to the longitudinal axis.
EEE 7 is the electric motor of any of EEEs 1-6, further comprising: a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.
EEE 8 is a system comprising: an electric motor comprising: a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto, and a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator; and at least one motor controller comprising: one or more inverter boards, each inverter board having a semiconductor switching matrix mounted thereon, wherein the semiconductor switching matrix comprises a plurality of semiconductor switching devices configured to convert direct current (DC) power to three-phase alternating current (AC) power to drive windings of the stator, and one or more controller boards that are electrically-coupled to the one or more inverter boards, wherein each controller board comprises a processor configured to generate a switching signal to operate the semiconductor switching matrix of a respective inverter board.
EEE 9 is the system of EEE 8, wherein the at least one motor controller comprises: a first inverter board configured to convert DC power to three-phase AC power to drive the first set of windings of the stator; a second inverter board configured to convert DC power to three-phase AC power to drive the second set of windings of the stator; and a controller board that is electrically-coupled to the first inverter board and the second inverter board, wherein the controller board generates a first switching signal to operate the first inverter board and a second switching signal to operate the second inverter board.
EEE 10 is the system of EEE 8, wherein the at least one motor controller comprises: a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.
EEE 11 is the system of EEE 10, further comprising: a first power source providing DC power to the first motor controller to be converted by the first inverter board to AC power to drive the first set of windings; and a second power source providing DC power to the second motor controller to be converted by the second inverter board to AC power to drive the second set of windings.
EEE 12 is the system of any of EEEs 8-11, wherein the stator comprises: a stator plate; and a stator hub mounted to the stator plate, wherein the first set of windings are disposed in a circular array about a peripheral surface of the stator hub on a first side of the stator plate, and wherein the second set of windings are disposed in a circular array about an end face of the stator plate on a second side of the stator plate, opposite the first side.
EEE 13 is the system of any of EEEs 8-12, wherein the rotor comprises: a rotor cylinder; and a rotor end plate coupled to the rotor cylinder, wherein the first set of magnets are disposed in a circular array about a respective peripheral surface of the rotor cylinder, and wherein the second set of magnets are disposed in a circular array about a respective end face of the rotor end plate.
EEE 14 is the system of EEE 13, wherein the first set of magnets are disposed in a circular array about an interior peripheral surface of the rotor cylinder, wherein the second set of magnets are disposed in a circular array about an interior end face of the rotor end plate, wherein the first set of windings are disposed in a circular array about an exterior peripheral surface of the stator, wherein the second set of windings are disposed in a circular array about an exterior end face of the stator, and wherein the rotor cylinder has an open end through which the stator is inserted, such that the stator is disposed, at least partially, within the rotor cylinder.
EEE 15 is the system of any of EEEs 13-14, wherein the rotor further comprises a rotor shaft coupled to the rotor end plate and configured to rotate about a longitudinal axis of the rotor shaft, wherein the radial magnetic flux is perpendicular to the longitudinal axis, and wherein the axial magnetic flux is parallel to the longitudinal axis.
EEE 16 is a vehicle comprising: a propeller or lift rotor; an electric motor configured to drive the propeller or lift rotor, wherein the electric motor comprises: a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto, and a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator; at least one motor controller comprising: (i) one or more inverter boards, each inverter board configured to convert direct current (DC) power to three-phase alternating current (AC) power to drive windings of the stator; and (ii) one or more controller boards that are electrically-coupled to the one or more inverter boards, wherein each controller board comprises a processor configured to operate a respective inverter board; and a plurality of battery modules configured provide DC power to the at least one motor controller to be converted by the one or more inverter boards to AC power.
EEE 17 is the vehicle of EEE 16, wherein the at least one motor controller comprises: a first inverter board configured to convert DC power to three-phase AC power to drive the first set of windings of the stator; a second inverter board configured to convert DC power to three-phase AC power to drive the second set of windings of the stator; and a controller board that is electrically-coupled to the first inverter board and the second inverter board, wherein the controller board generates a first switching signal to operate the first inverter board and a second switching signal to operate the second inverter board.
EEE 18 is the vehicle of EEE 16, wherein the at least one motor controller comprises: a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.
EEE 19 is the vehicle of EEE 18, wherein the plurality of battery modules comprise: a first battery module providing DC power to the first motor controller to be converted by the first inverter board to AC power to drive the first set of windings; and a second battery module providing DC power to the second motor controller to be converted by the second inverter board to AC power to drive the second set of windings.
EEE 20 is a method comprising: providing direct current (DC) power from a first power source to a first motor controller, wherein the first motor controller comprises: (i) a first inverter board configured to convert the DC power to three-phase alternating current (AC) power to drive a first set of windings of a stator of an electric motor, and (ii) a first controller board that is electrically-coupled to the first inverter board, wherein the first controller board generates a first switching signal to operate the first inverter board, wherein the first set of windings are configured to generate a radial magnetic flux when electric current is provided thereto, wherein the stator further comprises a second set of windings configured to generate an axial magnetic flux when electric current is provided thereto, and wherein the electric motor further comprises: a rotor comprising (i) a first set of magnets configured to interact with the radial magnetic flux generated by the first set of windings, and (ii) a second set of magnets configured to interact with the axial magnetic flux generated by the second set of windings; and providing DC power from a second power source to a second motor controller, wherein the second motor controller comprises: (i) a second inverter board configured to convert the DC power to three-phase AC power to drive the second set of windings, and (ii) a second controller board that is electrically-coupled to the second inverter board, wherein the second controller board generates a second switching signal to operate the second inverter board.

What is claimed is:

1. An electric motor comprising:
a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto; and
a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator.

2. The electric motor of claim 1, wherein the stator comprises:
a stator plate; and
a stator hub mounted to the stator plate, wherein the first set of windings are disposed in a circular array about a peripheral surface of the stator hub on a first side of the stator plate, and wherein the second set of windings are disposed in a circular array about an end face of the stator plate on a second side of the stator plate, opposite the first side.

3. The electric motor of claim 2, wherein the stator hub comprises a bearing housing configured to have a bearing that supports a rotor shaft coupled to the rotor.

4. The electric motor of claim 1, wherein the rotor comprises:
a rotor cylinder; and
a rotor end plate coupled to the rotor cylinder, wherein the first set of magnets are disposed in a circular array about a respective peripheral surface of the rotor cylinder, and wherein the second set of magnets are disposed in a circular array about a respective end face of the rotor end plate.

5. The electric motor of claim 4, wherein the first set of magnets are disposed in a circular array about an interior peripheral surface of the rotor cylinder, wherein the second set of magnets are disposed in a circular array about an interior end face of the rotor end plate, wherein the first set of windings are disposed in a circular array about an exterior peripheral surface of the stator, wherein the second set of windings are disposed in a circular array about an exterior end face of the stator, and wherein the rotor cylinder has an open end through which the stator is inserted, such that the stator is disposed, at least partially, within the rotor cylinder.

6. The electric motor of claim 4, wherein the rotor further comprises a rotor shaft coupled to the rotor end plate and configured to rotate about a longitudinal axis of the rotor shaft, wherein the radial magnetic flux is perpendicular to the longitudinal axis, and wherein the axial magnetic flux is parallel to the longitudinal axis.

7. The electric motor of claim 1, further comprising:
a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and
a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.

8. A system comprising:
an electric motor comprising:
a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto, and
a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator; and
at least one motor controller comprising:
one or more inverter boards, each inverter board having a semiconductor switching matrix mounted thereon, wherein the semiconductor switching matrix comprises a plurality of semiconductor switching devices configured to convert direct current (DC) power to three-phase alternating current (AC) power to drive windings of the stator, and
one or more controller boards that are electrically-coupled to the one or more inverter boards, wherein each controller board comprises a processor configured to generate a switching signal to operate the semiconductor switching matrix of a respective inverter board.

9. The system of claim 8, wherein the at least one motor controller comprises:
a first inverter board configured to convert DC power to three-phase AC power to drive the first set of windings of the stator;
a second inverter board configured to convert DC power to three-phase AC power to drive the second set of windings of the stator; and
a controller board that is electrically-coupled to the first inverter board and the second inverter board, wherein the controller board generates a first switching signal to operate the first inverter board and a second switching signal to operate the second inverter board.

10. The system of claim 8, wherein the at least one motor controller comprises:
a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and
a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.

11. The system of claim 10, further comprising:
a first power source providing DC power to the first motor controller to be converted by the first inverter board to AC power to drive the first set of windings; and
a second power source providing DC power to the second motor controller to be converted by the second inverter board to AC power to drive the second set of windings.

12. The system of claim 8, wherein the stator comprises:
a stator plate; and
a stator hub mounted to the stator plate, wherein the first set of windings are disposed in a circular array about a peripheral surface of the stator hub on a first side of the stator plate, and wherein the second set of windings are disposed in a circular array about an end face of the stator plate on a second side of the stator plate, opposite the first side.

13. The system of claim 7, wherein the rotor comprises:
a rotor cylinder; and
a rotor end plate coupled to the rotor cylinder, wherein the first set of magnets are disposed in a circular array about a respective peripheral surface of the rotor cylinder, and wherein the second set of magnets are disposed in a circular array about a respective end face of the rotor end plate.

14. The system of claim 13, wherein the first set of magnets are disposed in a circular array about an interior peripheral surface of the rotor cylinder, wherein the second set of magnets are disposed in a circular array about an interior end face of the rotor end plate, wherein the first set of windings are disposed in a circular array about an exterior peripheral surface of the stator, wherein the second set of windings are disposed in a circular array about an exterior end face of the stator, and wherein the rotor cylinder has an open end through which the stator is inserted, such that the stator is disposed, at least partially, within the rotor cylinder.

15. The system of claim 13, wherein the rotor further comprises a rotor shaft coupled to the rotor end plate and configured to rotate about a longitudinal axis of the rotor shaft, wherein the radial magnetic flux is perpendicular to the longitudinal axis, and wherein the axial magnetic flux is parallel to the longitudinal axis.

16. A vehicle comprising:
a propeller or lift rotor;
an electric motor configured to drive the propeller or lift rotor, wherein the electric motor comprises:
a stator comprising (i) a first set of windings disposed about a peripheral surface of the stator and configured to generate a radial magnetic flux when electric current is provided thereto, and (ii) a second set of windings disposed about an end face of the stator and configured to generate an axial magnetic flux when electric current is provided thereto, and
a rotor comprising (i) a first set of magnets disposed about a respective peripheral surface of the rotor, facing the first set of windings of the stator and configured to interact with the radial magnetic flux generated by the first set of windings of the stator, and (ii) a second set of magnets disposed about a respective end face of the rotor, facing the second set of windings of the stator and configured to interact with the axial magnetic flux generated by the second set of windings of the stator;
at least one motor controller comprising: (i) one or more inverter boards, each inverter board configured to convert direct current (DC) power to three-phase alternating current (AC) power to drive windings of the stator; and (ii) one or more controller boards that are electrically-coupled to the one or more inverter boards, wherein each controller board comprises a processor configured to operate a respective inverter board; and
a plurality of battery modules configured provide DC power to the at least one motor controller to be converted by the one or more inverter boards to AC power.

17. The vehicle of claim 16, wherein the at least one motor controller comprises:
a first inverter board configured to convert DC power to three-phase AC power to drive the first set of windings of the stator;
a second inverter board configured to convert DC power to three-phase AC power to drive the second set of windings of the stator; and
a controller board that is electrically-coupled to the first inverter board and the second inverter board, wherein the controller board generates a first switching signal to operate the first inverter board and a second switching signal to operate the second inverter board.

18. The vehicle of claim 16, wherein the at least one motor controller comprises:
a first motor controller comprising: (i) a first inverter board configured to convert DC power to three-phase AC power to drive the first set of windings of the stator, and (ii) a first controller board that is electrically-coupled to the first inverter board, wherein the first controller board generates a first switching signal to operate the first inverter board; and
a second motor controller comprising: (i) a second inverter board configured to convert DC power to three-phase AC power to drive the second set of windings of the stator, and (ii) a second controller board that is electrically-coupled to the second inverter board, wherein the second controller board generates a second switching signal to operate the second inverter board.

19. The vehicle of claim 18, wherein the plurality of battery modules comprise:
a first battery module providing DC power to the first motor controller to be converted by the first inverter board to AC power to drive the first set of windings; and
a second battery module providing DC power to the second motor controller to be converted by the second inverter board to AC power to drive the second set of windings.

20. A method comprising:
providing direct current (DC) power from a first power source to a first motor controller, wherein the first motor controller comprises: (i) a first inverter board configured to convert the DC power to three-phase alternating current (AC) power to drive a first set of windings of a stator of an electric motor, and (ii) a first controller board that is electrically-coupled to the first inverter board, wherein the first controller board generates a first switching signal to operate the first inverter board, wherein the first set of windings are configured to generate a radial magnetic flux when electric current is provided thereto, wherein the stator further comprises a second set of windings configured to generate an axial magnetic flux when electric current is provided thereto, and wherein the electric motor further comprises: a rotor comprising (i) a first set of magnets configured to interact with the radial magnetic flux generated by the first set of windings, and (ii) a second set of magnets configured to interact with the axial magnetic flux generated by the second set of windings; and
providing DC power from a second power source to a second motor controller, wherein the second motor controller comprises: (i) a second inverter board configured to convert the DC power to three-phase AC power to drive the second set of windings, and (ii) a second controller board that is electrically-coupled to the second inverter board, wherein the second controller board generates a second switching signal to operate the second inverter board.
